(19) United States
(12) Patent Application Publication
(10) Pub. No.: US 2011/0012841 A1
(43) Pub. Date: Jan. 20, 2011

(54) TRANSPARENT TOUCH PANEL CAPABLE OF BEING ARRANGED BEFORE DISPLAY OF ELECTRONIC DEVICE

(76) Inventor: Teh-Zheng Lin, Taoyuan (TW)

Correspondence Address: Teh-Zheng Lin;Teh-Zheng Lin, 235 Chung - Ho Box 8-24 Taipei, Taiwan, R. O. C., 235 Chung - Ho Box 8-24 Taipei, Taiwan, R. O. C., Taipei, 235, omitted

(21) Appl. No.: 12/506,249

(22) Filed: Jul. 20, 2009

(51) Int. Cl. G06F 3/041

(52) U.S. Cl. 345/173

(57) ABSTRACT

An assembly of a touch panel includes a transparent substrate, a color frame formed on edges of the substrate, and at least one touch sensing unit arranged insulated on the substrate. Signal wires formed on edges of the touch sensing unit are located below the color frame. The color frame is a thin film with a thickness below 5 μm. The assembly is thus simplified and thinner so that the cost is lowered and the product yield is raised. Also, an optical characteristic and a thickness of the product is improved and reduced. A surface of the touch sensing unit further has at least one transparent isolating layer or shielding layer, and at least one light regulating layer or functional film is arranged to a surface of the substrate.

### FIELD OF THE PRESENT INVENTION

The present invention relates to touch panel, and particular to a transparent one capable of being arranged before a display of an electronic device for users to perform interacting operation.

### DESCRIPTION OF THE PRIOR ART

With the rapid advancement of the panel technology, touch panels nowadays have substantially improvement in quality but have lower price so that it is widely applied to consuming electronics such as mobile phone, digital camera, media player (MP3), personal digital assistor (PDA), and global positioning system (GPS). On these electronic devices, touch panels are arranged in front of the display for users to perform input so as to improve operating efficiency and make the interface friendly.

Referring to FIGS. 13 to 15, prior flat touch panel 500 is attached to a display with a decorating plate 600 attached above. The prior touch panel 500 has a touch sensing unit 501 arranged between an upper substrate 502 and a bottom substrate 503. The decorating plate 600 is a transparent layer, and a color decorating frame 601 is formed on a periphery thereof so as to cover the signal wires 501a formed on edges of the touch sensing unit. The above components are made of transparent material so that the touch panel can be equipped to displays of electronic devices for users to perform signal input by touching or pressing on the touch panel.

Therefore, prior decorating plate 600 and touch panel 500 are formed separately and attached together by a transparent gluing layer 700 (optical glue). Such process is complicated, and the optical glue is expensive. Not only the cost and material are easily wasted, but the thick thickness of the assembly will damage the optic characteristic.

### SUMMARY OF THE PRESENT INVENTION

Accordingly, the primary object of the present invention is to provide an improved assembly of touch panel. A color frame and touch sensing unit are directly formed to a substrate of the touch panel so that the prior decorating plate, transparent plate, and gluing layer are skipped. The cost and manufacturing is saved and simplified, and the yield and the optical characteristic are raised.

To achieve above object, the present invention provides an assembly of touch panel comprising: a substrate being a physical transparent thin plate; a color frame formed to a peripheral of a surface of the substrate; the color frame being an opaque or nearly opaque thin film; at least one touch sensing unit arranged to a surface of the substrate; signal wires on edges of the touch sensing unit being arranged below the color frame; sensing signals being generated by touching the touch sensing unit, then being transmitted by the signal wires arranged on the edges.

The substrate is a thin plate made of one of glass, polycarbonate (PC), polyester (PET), polymethyl methacrylate (PMMA), or Cyclo-Olefin Copolymers (COC). The substrate is one of a plane or non-plane thin plate. The color frame is made of one of ink, color photo resistance, organic material or inorganic material. The color frame is a thin film with a thickness below 5 μm. The touch sensing unit is one or a combination of a capacitive touch sensing unit, resistive touch sensing unit or electromagnetic touch sensing unit. A surface of the substrate has a light regulating layer which is one or stacking films of a polarized thin film, phase shift thin film, and optical isotropic film. A functional film is arranged on top of the surface of the substrate; the functional film is one of a nebulizing film or a hard coating. A transparent isolating layer is arranged to the surface of the touch sensing unit. The isolating layer is an insulated layer. A transparent shielding layer is arranged to an outer surface of the isolating layer to block noises.

The above touch panel is equipped in front of a display so that users can perform an input by touching on a specific location of the touch panel under the instruction displayed on the display. When a finger or a conductor touches a certain position on the transparent substrate, a capacitive signal will be generated by the capacitive sensing unit so that the position will be located by the variation of the capacitive signal. Comparing with the prior art, the present invention removes the transparent plate and gluing layer arranged on top of prior touch panel and bottom substrate arranged to prior touch panel so that the cost will be saved. Also, the attach process is simplified so that the yield is improved an optical characteristic and thickness of the product is improved and reduced.

### BRIEF DESCRIPTION OF THE DRAWINGS

FIG. 1 is a cross-section view showing an assembly of a first embodiment of the present invention.

FIG. 2 is a top view of a single layer capacitive touch sensing unit of the first embodiment of the present invention.

FIG. 3 is an enlarge view showing a part A of the FIG. 2.

FIG. 4 is a top view showing another single layer capacitive touch sensing unit of the first embodiment of the present invention.

FIG. 5 is a cross-section view showing an assembly of a second embodiment of the present invention.

FIG. 6 is a cross-section view showing an assembly of a third embodiment of the present invention.

FIG. 7 is a cross-section view showing an assembly of a fourth embodiment of the present invention.

FIG. 8 is a cross-section view showing an assembly of a fifth embodiment of the present invention.

FIG. 9 is a cross-section view showing an assembly of a sixth embodiment of the present invention.

FIG. 10 is a cross-section view showing an assembly of a seventh embodiment of the present invention.

FIG. 11 is a cross-section view showing an assembly of an eighth embodiment of the present invention.

FIG. 12 is a cross-section view showing an assembly of a ninth embodiment of the present invention.

FIG. 13 is a schematic view showing an assembly of the prior art.

FIG. 14 is a schematic view showing the prior art.

FIG. 15 is a cross-section view showing the assembly of the prior art.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

Referring to FIG. 1, a first preferable embodiment of the present invention is shown. The embodiment in the following is applied in a capacitive touch panel. However, the present invention is not only applicable in the capacitive touch panel, it can also be applied to a resistive touch panel or an electromagnetic touch panel.

In the first embodiment of the present invention, the touch panel assembly includes a transparent substrate 10, a color frame 20, and a touch sensing unit 30. The transparent substrate 10 is made of physical transparent material such as a thin glass or other flexible thin plate such as polycarbonate (PC), polyester (PET), polymethyl methacrylate (PMMA), Cyclo-Olefin Copolymers (COC). Except previous material, the transparent substrate 10 also can be made of other soft, hard, transparent or semi-transparent substrate.

The color frame 20 is made of ink, color photo resistance, and organic material or inorganic material but not restricted within previous materials. The above materials are arranged to a periphery of a bottom surface of the transparent substrate 10 by means of printing, coating, or metal evaporating. An opaque thin film with a thickness about 1 μm is formed to the color frame 20, while the process is not restricted within above means.

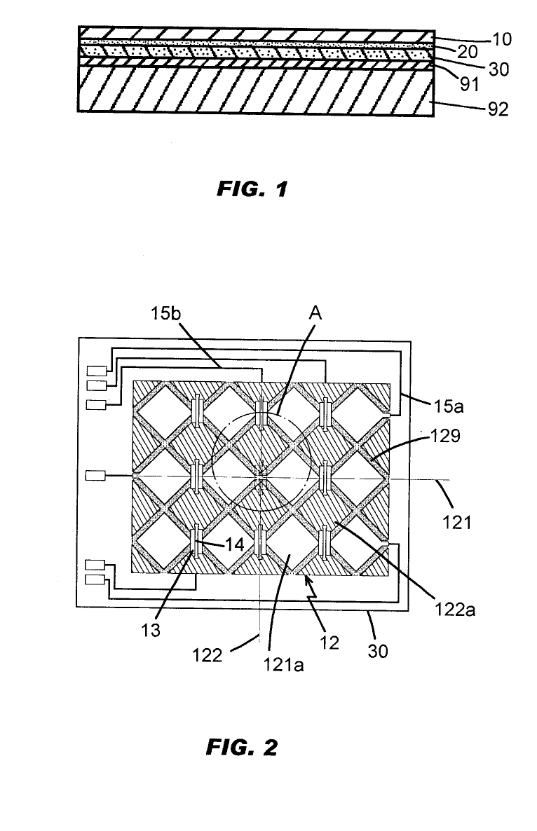

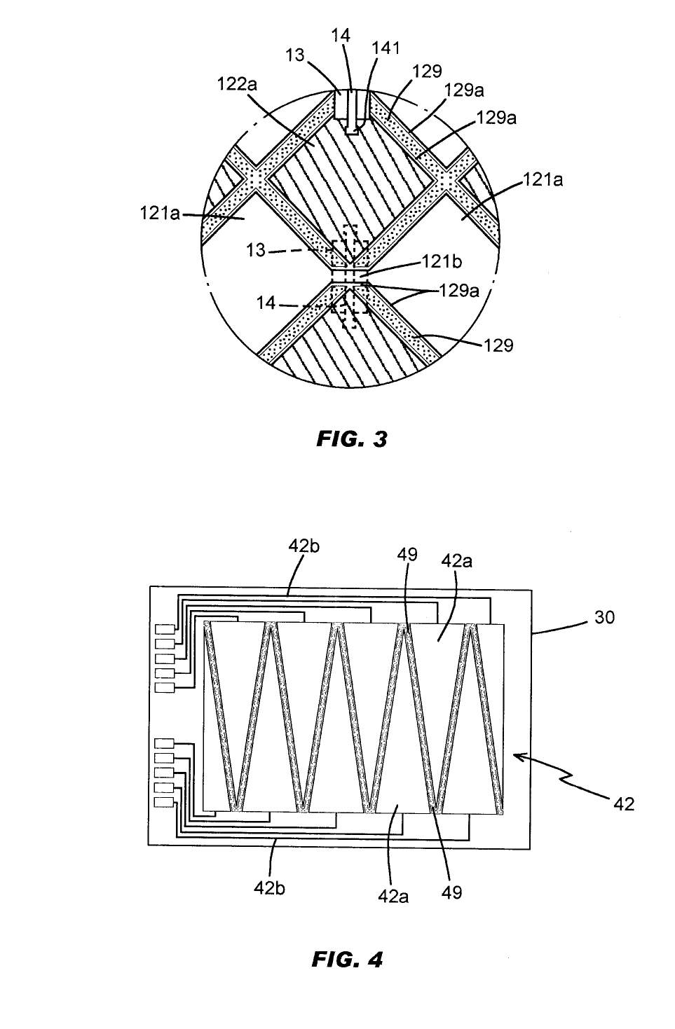

The touch sensing unit 30 is arranged to bottom surfaces of the transparent substrate 10 and the color frame 20 so that signal wires on the edge of the touch sensing unit 30 are located under the color frame 20. The color frame 20 will cover the signal wire of the touch sensing unit 30 so that an appearance of the panel can be improved. The touch sensing unit 30 of the embodiment of the present invention is a single layer capacitive touch sensing device as shown in FIGS. 2 and 3. The touch sensing unit 30 includes a capacitive sensing layer 12, an isolating layer 13 and an inducting layer 14. The capacitive sensing layer 12 is a transparent conductive thin film made of Indium Tin Oxide. The capacitive sensing layer 12 includes a plurality of transparent X axis traces 121 which are arranged in parallel with a fixed interval between, and also includes a plurality of transparent Y axis traces 122 which are arranged in parallel with a fixed interval between. The X and Y traces 121, 122 intersect with each other as a matrix. Induction-spots 121a are formed on each X axis trace 121 and are connected one by one, and induction-spots 122a are formed on each Y axis trace but are formed separately with gaps. An end of each X and Y axis trace is separately conducted to metal conducting wires 15a and 15b formed on edges of the substrate 10 and then conduct to a signal output terminal (not shown). Through above connections, sensing signals generated by the X axis traces 121 and Y axis traces 122 on the capacitive sensing layer 12 can be transmitted to a succeeding signal processing circuit. The isolating layer 13 consists of a plurality of distributed small-area insulated thin films made of highly transparent Polythylene terephthalate with a permittivity about 3 and a thickness about 1.5 μm, and each insulated film of the isolating layer 13 will cover at least the Induction-spots 121b of the X axis trace 121 which lies between two adjacent induction-spots 122a of the Y axis trace 122. The inducting layer 14 consists of a plurality of conducting wires formed along the direction of the Y axis traces. Each conducting wire is made of an opaque metal conductor with a diameter less than 15 μm. On two ends of each conducting wire of the inducting layer 14, electrical joints 141 with wider contact area than that of the conducting wire itself are formed. Each conducting wire of the inducting layer 14 is formed on a top surface of each insulated film of the isolating layer 13, and the electrical joints 141 of the conducting wire are arranged outside the insulated film so as to connect the two adjacent induction-spots 122a below the insulated film. In an assembly of the capacitive sensing layer 12, isolating layer 13, and the inducting layer 14, the insulated films of the isolating layer 13 will cover sections of the X axis traces 121 lay between two adjacent induction-spots 122a of the Y axis traces 122, and the electrical joints 141 on the conducting wires of the inducting layer 14 will contact the two adjacent induction-spots 122a of the Y axis traces 121 respectively to electrically connect each induction-spot on Y axis traces. Moreover, decorating strips 129 are arranged between the induction-spots 121a of the X axis traces 121 and induction-spots 122a of the Y axis traces 122 on the capacitive sensing layer 12. A gap 129a is formed between the decorating strips 129 and the induction-spots 121a and 122a so that the decorating strips 129 will not contact to the induction-spots. The gap 129a is normally between 20 μm to 50 μm. The decorating strips 129 are ideally made of the same material of the induction-spots 121a and 122a which is a transparent conductive thin film of Indium Tin Oxide so that the transparency of the capacitive sensing layer 12 is uniformly. Referring to FIG. 4, an assembly of another single layer capacitive touch sensing unit 30 is shown. The assembly includes a capacitive sensing layer 42 which is a transparent conductive thin film made of Indium Tin Oxide. A plurality of approximately triangular induction-spots 42a is formed interlaced with a predetermined gap between. An end of each induction-spot 42 is connected to a metal conducting wire 42b separately formed to edges of a transparent substrate 10 and then conduct to a signal output terminal (not shown). Through above connections, sensing signals generated by the induction-spots 42a can be transmitted to a succeeding signal processing circuit. Moreover, decorating strips 49 are arranged between the induction-spots 42a. A gap 49a is formed between the decorating strips 129 and the induction-spots 42a so that the decorating strips 49 will not contact to the induction-spots 42a. The gap 49a is normally between 20 μm to 50 μm. The decorating strips 49 are ideally made of the same material of the induction-spots 42a.

The above touch panel are equipped in front of a display 92 by a gluing layer 91 so that users can perform an input by finger touch on a specific location of the display 92 under the instruction displayed on the display 92. When a finger or a conductor touches a certain position on the transparent substrate 10, a capacitive signal will be generated by the capacitive sensing unit 30 so that the position will be located by sensing the variation of the capacitive signal.

Comparing with the prior art, the embodiment of the present invention removes the transparent plate and gluing layer arranged on top of prior touch panel and bottom substrate arranged to prior touch panel so that the cost will be saved. With the color frame 20 formed directly to the transparent substrate 10, a gluing process to glue the substrate and decorating plate of the prior touch panel is skipped so that the cost is lowered and the product yield is raised. Also, an optical characteristic and a thickness of the product is improved and reduced.

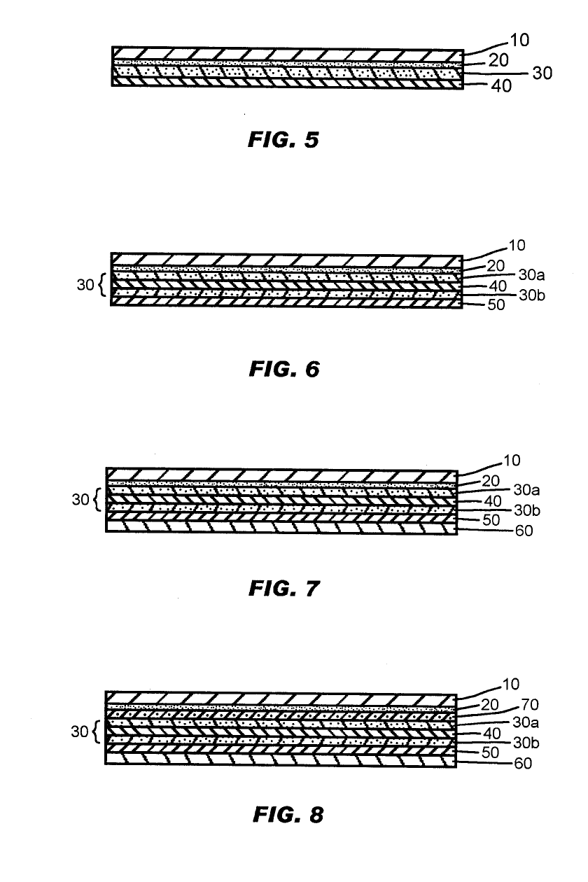

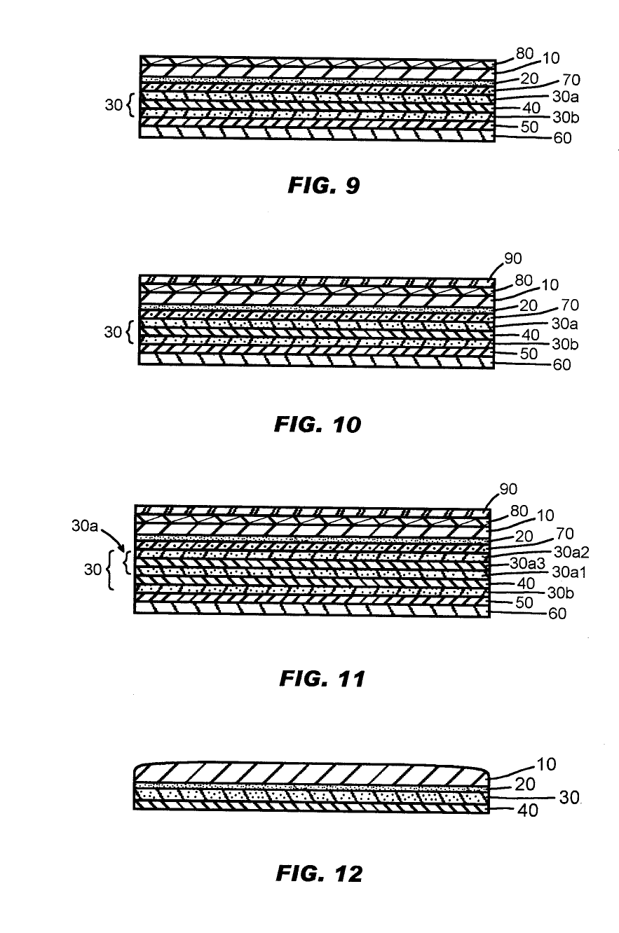

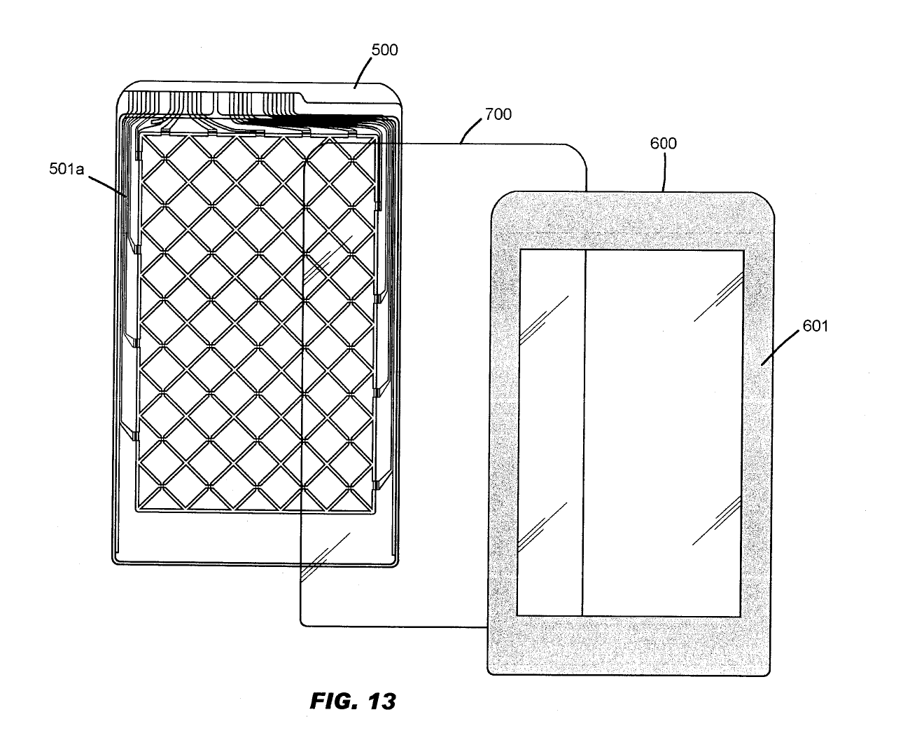

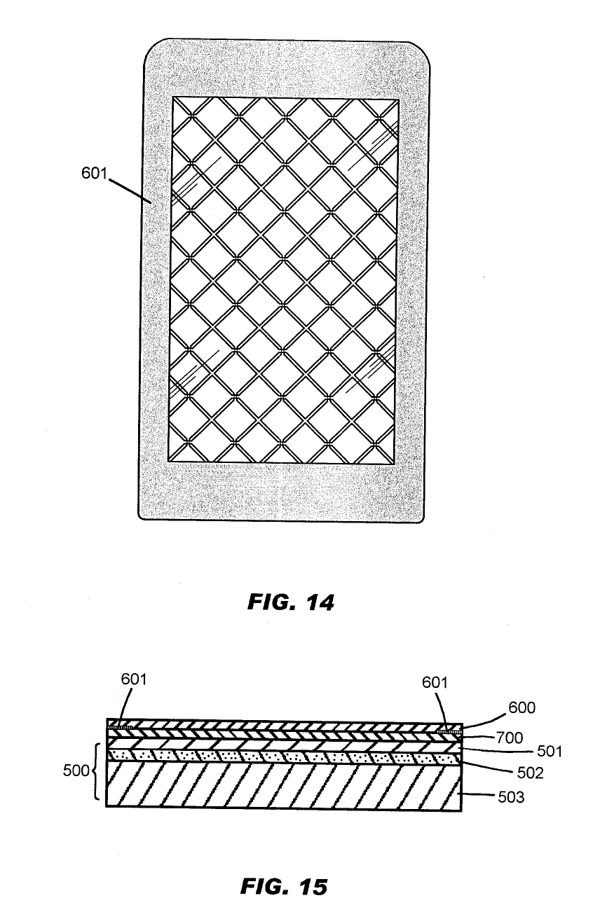

However, based on the first embodiment mentioned above, modifications can be done to the touch panel for different operation conditions. For example, a second embodiment of the present invention is shown in FIG. 5. A transparent insulating layer 40 is arranged to a bottom surface of a touch sensing unit 30. The insulating layer 40 is made of silicon nitride, silicon dioxide, photo resistance, or other materials. The bottom surface of the touch sensing unit 30 will be protected by the transparent insulating layer 40 from scratching. Referring to a third embodiment of the present invention shown in FIG. 6, the touch sensing unit 30 has a transparent insulating layer 40 arranged between a transparent electrode layer 30a and a metal conducting wire 30b. A transparent protecting shield 50 is arranged to a bottom surface of the metal conducting wire 30b so that the transparent electrode layer 30a and the metal conducting wire 30b can be arranged insulated to the touch panel. The transparent electrode layer 30a is made of Indium Tin Oxide, Indium Zinc Oxide, or Aluminum Zinc Oxide. The isolating layer 40 and the protecting shield 50 are made of silicon nitride, silicon dioxide, photo resistance, or other materials. Moreover, a fourth embodiment of the present invention is illustrated in FIG. 7. Based on the assembly of the third embodiment mentioned above, a shielding layer 60 is arranged below the transparent protecting shield 50. The shielding layer 60 is made of transparent conductive material such as Indium Tin Oxide or Indium Zinc Oxide. The shielding layer 60 conducting ground potential can block an interference of electromagnetic wave to the touch sensing unit 30. Furthermore, a fifth embodiment of the present invention is illustrated in FIG. 8. Based on the fourth embodiment mentioned above, a transparent protecting shield 70 is arranged between a bottom side of the transparent substrate 10 and the color frame 20 to the transparent electrode layer 30a of the touch sensing unit 30 so as to smoothen the gluing and to prevent bubble remained on edges of the color frame 20. The protecting shield 70 is made of silicon nitride, silicon dioxide, photo resistance, or other materials. Furthermore, a sixth embodiment of the present invention is illustrated to FIG. 9. Based on the fifth embodiment mentioned above, a light regulating layer 80 is arranged to an upper surface of the transparent substrate 10 so as to improve a visibility of the display. The light regulating layer 80 is made of one or combination of the polarized thin film, phase shift thin film, and optical isotropic film. Based on the sixth embodiment mentioned above, a seventh embodiment illustrated in FIG. 10 has a functional film 90 above the light adjusting film 80. The functional film 90 can be a nebulizing film, hard coating, or others so as to lower the reflective index of the panel or to improve the hardness against scratching and rubbing. Based on the seventh embodiment, an eighth embodiment illustrated in FIG. 11 has double electrode layers including an upper transparent electrode layer 30a1, a lower electrode layer 30a2, and a transparent insulated layer 30a3 between the two electrode layers. The upper and lower electrode layers are made of Indium Tin Oxide, Indium Zinc Oxide, or Aluminum Zinc Oxide. The insulated layer 30a3 is made of silicon nitride, silicon dioxide, photo resistance, or other materials.

The present invention is thus described, it will be obvious that the same may be varied in many ways. For example, a curved plate or a non-plane plate as shown in FIG. 12 instead of a plane substrate 10 is applied to the touch panel for special operation conditions. Such variations are not to be regarded as a departure from the spirit and scope of the present invention, and all such modifications as would be obvious to one skilled in the art are intended to be included within the scope of the following claims.

What is claimed is:

1. An assembly of touch panel comprising:
a substrate being a physical transparent thin plate;
a color frame formed to a peripheral of a surface of the substrate; the color frame being an opaque or nearly opaque thin film;
at least one touch sensing unit arranged to a surface of the substrate; signal wires on edges of the touch sensing unit being arranged below the color frame; sensing signals being generated by touching the touch sensing unit, then being transmitted by the signal wires arranged on the edges.

2. The assembly of touch panel as claimed in claim 1, wherein the substrate is a thin plate made of one of glass, polycarbonate (PC), polyester (PET), polymethyl methacrylate (PMMA), or Cyclo-Olefin Copolymers (COC).

3. The assembly of touch panel as claimed in claim 1, wherein the substrate is one of a plane or non-plane thin plate.

4. The assembly of touch panel as claimed in claim 1, wherein the color frame is made of one of ink, color photo resistance, organic material or inorganic material.

5. The assembly of touch panel as claimed in claim 1, wherein the color frame is a thin film with a thickness below 5 μm.

6. The assembly of touch panel as claimed in claim 1, wherein the touch sensing unit is one or a combination of a capacitive touch sensing unit, resistive touch sensing unit or electromagnetic touch sensing unit.

7. The assembly of touch panel as claimed in claim 1, wherein a surface of the substrate has a light regulating layer which is one or stacking films of a polarized thin film, phase shift thin film, and optical isotropic film.

8. The assembly of touch panel as claimed in claim 1, wherein a functional film is arranged on top of the surface of the substrate; the functional film is one of a nebulizing film or a hard coating.

9. The assembly of touch panel as claimed in claim 1, wherein a transparent isolating layer is arranged to the surface of the touch sensing unit.

10. The assembly of touch panel as claimed in claim 9, wherein the isolating layer is an insulated layer.

11. An assembly of touch panel as claimed in claim 9, wherein a transparent shielding layer is arranged to an outer surface of the isolating layer to block noises.
